(19) United States
(12) Patent Application Publication
(10) Pub. No.: US 2016/0064960 A1
(43) Pub. Date: Mar. 3, 2016

(54) USER-BEHAVIOR-DRIVEN BATTERY CHARGING

(71) Applicant: Apple Inc., Cupertino, CA (US)

(72) Inventors: Derek J. DiCarlo, Mountain View, CA (US); Hongli Dai, Los Altos, CA (US); Steve Sterz, Cupertino, CA (US); Richard M. Mank, Los Altos, CA (US); Soundar Manthiri, Cupertino, CA (US)

(21) Appl. No.: 14/843,602

(22) Filed: Sep. 2, 2015

Related U.S. Application Data
(60) Provisional application No. 62/044,482, filed on Sep. 2, 2014.

(51) Int. Cl. H02J 7/00

(52) U.S. Cl. CPC H02J 7/007; H02J 7/0021

(57) ABSTRACT

The disclosed embodiments provide a system that manages use of a battery in a portable electronic device. During, operation, the system monitors indicators of user behavior associated with charging and discharging of the battery in the portable electronic device by a user, wherein the indicators of user behavior can include a state-of-charge of the battery, a charging pattern associated with charging of the battery, usage of applications on the portable electronic device, a user setting on the portable electronic device, a scheduled event or alarm on the portable electronic device, a power consumption pattern on the portable electronic device, a time of day, or the location of the portable electronic device. Next, the system modifies a charging technique for the battery based on the monitored indicators of user behavior to manage at least one of a cycle life of the battery, swelling in the battery, and a runtime of the battery.

### CROSS-REFERENCE TO RELATED APPLICATIONS

This Non-Provisional application claims the benefit of U.S. Provisional Application No. 62/044,482, filed Sep. 2, 2014, the entire contents of which is incorporated by reference herein.

### BACKGROUND

The disclosed embodiments relate to batteries for portable electronic devices. More specifically, the disclosed embodiments relate to techniques for charging batteries based on user behavior associated with charging and discharging of the batteries in the portable electronic devices.

Portable electronic devices, such as laptop computers, portable media players, and/or mobile phones, typically operate using a rechargeable battery. Furthermore, designs for such batteries often include battery packs that contain battery cells connected in various series and parallel configurations. For example, a six-cell battery pack of cells may be configured in a three in series, two in parallel (3s2p) configuration. Hence, if a single cell can provide a maximum of 3 Amps with a voltage ranging from 2.7 Volts to 4.2 Volts, then the entire battery pack can have a voltage range of 8.1 Volts to 12.6 Volts and provide 6 Amps of current.

During operation, the battery's capacity may diminish over time from an increase in internal impedance, electrode and/or electrolyte degradation, excessive heat, and/or abnormal use. For example, oxidation of electrolyte and/or degradation of cathode and anode material within a battery may be caused by repeated charge-discharge cycles and/or age, which in turn may cause a gradual reduction in the battery's capacity. As the battery continues to age and degrade, the capacity's rate of reduction may increase, particularly if the battery is continuously charged to a high voltage.

Continued use of a battery over time may also produce swelling in the battery's cells and eventually cause the battery to exceed the designated maximum physical dimensions of the device. Moreover, conventional battery-monitoring mechanisms may not include functionality to manage swelling of the battery. As a result, a user of the device may not be aware of the battery's swelling and/or degradation until the swelling results in physical damage to the device.

Hence, what is needed is a mechanism for mitigating swelling and/or degradation in batteries, such as lithium-polymer batteries, for portable electronic devices.

### SUMMARY

The disclosed embodiments provide a system that manages use of a battery in a portable electronic device. During operation, the system monitors one or more indicators of user behavior associated with charging and discharging of the battery in the portable electronic device, and may modify one or more charging parameters based on the monitored indicators. When monitoring the one or more indicators, the system may monitor a state-of-charge of the battery, a charging pattern associated with charging of the battery, usage of applications on the portable electronic device, a user setting on the portable electronic device, a scheduled event or alarm on the portable electronic device, a power consumption pattern on the portable electronic device, a time of day, or the location of the portable electronic device. The system modifies charging parameters for the battery based on the user behavior, for example by altering a charge-termination voltage for a battery (i.e., a battery voltage at which the system stops charging the battery) or altering the timing and/or rate of charging of the battery. These modifications may help to manage at least one of a cycle life of the battery, swelling in the battery, and a runtime of the battery.

In some embodiments, monitoring the user behavior includes tracking a state-of-charge of the battery, and modifying the charging technique for the battery based on the user behavior includes adjusting a charge-termination voltage of the battery based on the tracked state-of-charge of the battery.

This application refers to three different maximum charge-termination voltages, including: (1) an “absolute maximum charge-termination voltage” that indicates the maximum voltage that the battery can possibly be charged to; (2) a “default maximum charge-termination voltage” (also referred to as a “maximum charge-termination voltage”), which is the highest voltage to which the system will allow the battery to be charged for a cell during a given charging cycle charge-termination; and (3) a variable charge-termination voltage, which is the voltage at which the system will terminate charging during a given charging cycle.

The absolute maximum charge-termination voltage may decrease over time as the battery ages. The default maximum charge-termination voltage is typically less than the absolute maximum charge-termination voltage (although in some instances the default maximum charge-termination may be set to the absolute maximum charge-termination voltage), and be calculated based on one or more parameters (including cycle count, battery age, battery impedance, temperature, combinations thereof and the like). For example, the default maximum charge-termination voltage may be decreased by the system as the cycle count increases, which may in turn extend the usable life of the battery. The variable charge-termination voltage may be less than or equal to the default charge-termination voltage. As will be described below, the variable charge-termination voltage may be lowered below the default maximum charge-termination voltage based on monitored user behavior. Lowering the maximum charge-termination voltage may further extend the battery life beyond the battery life achieved by charging to the default maximum charge-termination voltage, but may reduce the runtime of the device. Conversely, increasing the variable charge-termination voltage can increase the run time of the device, but may accelerate aging of the battery.

When determining the state-of-charge of a battery, the state-of-charge may be measured or otherwise calculated with respect to the three different maximum charge-termination voltages discussed above. Specifically, (1) an “absolute state-of-charge,” expresses the state-of-charge of the battery as a percentage of the state-of-charge of the battery when the battery is charged to the absolute maximum charge-termination voltage; (2) a “default state-of-charge” expresses the state of charge as a percentage of the state-of-charge of the battery when the battery is charged to the default maximum charge-termination voltage; and (3) a “variable state-of-charge” expresses the state of charge as a percentage of the state-of-charge of the battery when the battery reaches the variable charge-termination voltage. For example, if a battery is considered empty at 1 V, has an absolute maximum charge-termination voltage of 4 V, a default maximum charge termination voltage of 3 V, and a variable charge-termination voltage of 2V, the battery may have a 50% absolute state-of-charge, a 75% default maximum state-of-charge, and a 100% variable state-of-charge when the battery is charged to 2V. It should be appreciated that when the term “state-of-charge” is used without specifically referencing the absolute state-of-charge, the default state-of-charge, or the variable state-of-charge, that it may be applicable to any suitable measurement or calculation of the state-of-charge of a battery. Moreover, when a state of charge is displayed to the user, the state of charge may be any state of charge (e.g., the absolute state-of-charge, default state-of-charge, variable state of charge or the like) as desirable.

In some embodiments of the systems and methods described here, adjusting the variable charge-termination voltage of the battery based on the monitored state-of-charge may include reducing the variable charge-termination voltage to a first level below a maximum charge-termination voltage of the battery upon determining that the state-of-charge did not drop below a state-of-charge threshold within a first tracking period.

In some embodiments, adjusting the variable charge-termination voltage of the battery based on the monitored state-of-charge further includes reducing the variable charge-termination voltage to a second level below the first level upon determining that the state-of-charge does not drop below the state-of-charge threshold within a second tracking period after the variable charge-termination voltage is reduced to the first level.

In some embodiments, adjusting the variable charge-termination voltage of the battery based on the monitored state-of-charge further includes increasing the charge-termination level to a third level above the first level upon determining that the state-of-charge drops below the state-of-charge threshold within a second tracking period after the variable charge-termination voltage is reduced to the first level.

In some embodiments, the manner of charging a battery of a portable electronic device may at least partially be based on an estimated disconnection time of the portable electronic device from a power source. For example, when a user begins charging a portable electronic device (e.g., by connecting the portable electronic device to a power source), the portable electronic device may determine that the portable electronic device is connected to the power source. The device may estimate a disconnection time at which the portable electronic device will be disconnected from the power source, and may select a charging program based on the estimated disconnection time. The battery then may be charged (e.g., via power provided by the power source) according to the charging program.

In some embodiments, charging according to the charging program includes initially charging the battery, pausing charging of the battery after a state-of-charge of the battery reaches a pause threshold during the charging, and resuming charging of the battery a pre-specified amount of time prior to the estimated disconnection time. In embodiments, the charging program may pause charging of the battery after a charge capacity (in mAh) reaches a pause threshold or pause charging of the battery after the battery voltage reaches a battery threshold. In some instances after resuming charging, the battery will be charged until the battery is completely charged (or until the portable electronic device is actually disconnected by the user). In other instances, charging of the battery may be paused after the battery reaches a second threshold higher than the initial threshold. In these instances, charging of the battery may be resumed a second pre-specified amount of time prior to the estimated disconnection time.

In some embodiments, the estimated disconnection time may be estimated using a monitored charging pattern of a user. For example, the portable electronic may monitor the charging patterns of the user by measuring the amount of time the portable electronic device is connected to a power source (e.g., by measuring the amount of time between initial connection of the portable electronic device to and subsequent disconnection from a power source). In some embodiments, the estimated disconnection time may be estimated using one or more of: a day of the week during which the portable electronic device is connected to the power source, a time of day during which the portable electronic device is connected to the power source, a scheduled event on the portable electronic device, an alarm that is set on the portable electronic device; and, a location of the portable electronic device where portable electronic device is connected to the power source. In some instances, a charging rate of the battery may be selected based on the estimated disconnection time.

In some embodiments, monitoring the user behavior includes obtaining a user preference for a maximum state-of-charge from the user, and modifying the charging technique for the battery based on the user behavior includes adjusting a variable charge-termination voltage of the battery to be consistent with the user-specified maximum state-of-charge.

In some embodiments, the charging technique is adjusted using at least one of a processor, a charger and a battery management unit (BMU) for the battery.

### BRIEF DESCRIPTION OF THE DRAWINGS

FIG. 1 shows a portable electronic device in accordance with the disclosed embodiments.

FIG. 2 shows a flowchart illustrating the process of managing use of a battery in a portable electronic device in accordance with the disclosed embodiments.

FIG. 3 shows a flowchart illustrating the process of managing use of a battery in a portable electronic device in accordance with the disclosed embodiments.

FIG. 4 shows a flowchart illustrating the process of managing use of a battery in a portable electronic device in accordance with the disclosed embodiments.

FIG. 5 shows a flowchart illustrating the process of managing use of a battery in a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for monitoring and managing a battery in a portable electronic device. The battery may include one or more cells in a parallel and/or series configuration that supply power to a mobile phone, laptop computer, portable media player, tablet computer, and/or other battery-powered electronic device. For example, the battery include a lithium-polymer battery, but it should be appreciated that the battery may include any suitable rechargeable battery types (e.g., lithium-ion, lead-acid, nickel cadmium or the like). In use, the battery may be reused up to a number of charge cycles before losing enough capacity to reach an end-of-life capacity threshold. The battery may also swell as capacity diminishes over time.

In some of the disclosed embodiments, the portable electronic device may set a maximum charge-termination voltage and a variable charge-termination voltage. The maximum charge-termination voltage may be set based on the cycle count, impedance, swell rate, and/or other parameters associated with the operation, age, and/or health of the battery. For example, the maximum charge-termination voltage may be reduced over time to mitigate degradation and/or swelling in the battery and extend the battery's useful life. In some instances, user input may be used to alter or set the maximum charge-termination voltage (e.g., the maximum charge-termination voltage may be increased in response to a user request for longer device runtime, the maximum charge-termination voltage may be decreased in response to a user request for increased useful life of the battery, or the like).

The variable charge-termination voltage may be determined based on user behavior. For example, the variable charge-termination voltage may be decreased if the user consistently fails to discharge the battery below a pre-specified threshold and/or manually sets the variable charge-termination voltage to a percentage of the maximum charge-termination voltage to extend the cycle life of the battery.

The portable electronic device may provide a state-of-charge indicator (e.g., which may be displayed on a screen or display of the portable electronic device, may be audibly announced via a speaker, or the like), which may communicate the current state-of-charge to a user. In some instances, the state-of-charge indicator may output a default state-of-charge (i.e., that is calculated based on the default maximum charge-termination voltage), or a variable state-of-charge (i.e., that is calculated based on the variable charge-termination voltage). For example, the battery may have a variable charge-termination voltage that is set to 80% of the default maximum charge-termination voltage. In these instances, charging of the battery to the variable charge-termination voltage may result in the state-of-charge indicator communicating to a user a 100% state-of-charge (if based on the variable state-of-charge) or an 80% state of charge (if based on the default state-of-charge).

Many of the disclosed embodiments provide methods and systems for performing charging of the battery based on user behavior. During use of the portable electronic device by a user, the user's behavior associated with charging and discharging of the battery is monitored. One or more charging parameters or techniques for charging the battery is then modified based on the user behavior. These modifications may manage the cycle life of the battery, swelling in the battery, and/or the runtime of the battery. For example, the variable charge-termination voltage of the battery may be lowered if the user consistently does not discharge the battery below a pre-specified threshold. In these instances, since the user consistently does not use the full battery capacity before recharging the device, lowering the charge termination voltage may not result a noticeable change to the user in terms of device runtime, but may instead mitigate degradation and/or swelling in the battery to extend the battery's useful life. Similarly, a charging pattern associated with prolonged (e.g., overnight) charging of the battery may be identified, and charging of the battery may be paused at a level below the variable charge-termination voltage and resumed before the power source is estimated to be disconnected. This may reduce the battery's time at or near a full state-of-charge while the power source is connected, which may help limit premature aging of the battery that may occur as a result of holding the battery at or near a full state-of-charge. Such adjustments to the charging technique for the battery may thus enable dynamic management of the battery's cycle life, swelling, and runtime throughout the lifetime of the battery without negatively impacting the user's experience with the portable electronic device.

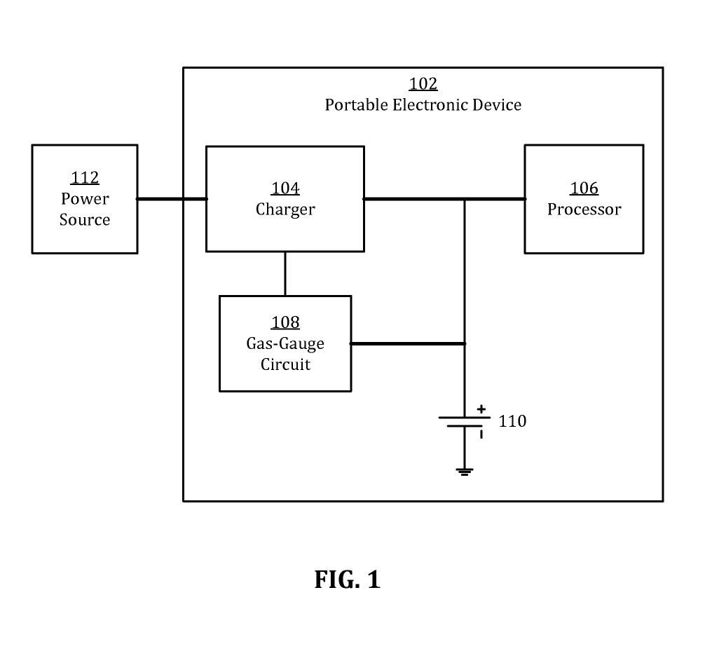

FIG. 1 shows a portable electronic device 102 in accordance with an embodiment. The portable electronic device 102 may be a mobile phone, personal digital assistant (PDA), laptop computer, tablet computer, portable media player, and/or peripheral device. Portable electronic device 102 may be connected to an external power source 112 such as a power adapter. In turn, power from power source 112 may be converted into a current and/or voltage that can be used to charge a battery 110 of electronic device 102 and/or operate components in portable electronic device 102. For example, a charger 104 and/or another component of portable electronic device 102 may direct power received from the power source 112 to charge a battery 110 of portable electronic device 102 and/or operate components (e.g., processor 106, memory, radio, display, input/output (I/O) devices, etc.) in electronic device 102. In some instances, the power source 112 may provide direct current (DC) power to the portable electronic device (e.g., the power source 112 may be configured to convert alternating current (AC) power to DC power). In other instances, the portable electronic device receives AC power from the power source 112 (e.g., the charger 104 and/or another component of the portable electronic device 102 may convert AC power to DC power).

Those skilled in the art will appreciate that reductions in the capacity of battery 110 may result from factors such as age, use, defects, heat, and/or damage. Furthermore, a decrease in battery capacity beyond a certain threshold (e.g., below 80% of initial capacity) may be accompanied by swelling of the battery that damages or distorts the portable electronic device.

First, charging and discharging of battery 110 may cause a reaction of electrolyte with cathode and anode material. The reaction may both decrease the capacity of battery 110 and cause swelling through enlargement of the electrode and/or gas buildup inside battery 110. Moreover, the reaction may be accelerated if battery 110 is operated at higher temperatures and/or continuously charged to high voltages. For example, a lithium-polymer battery that is operated at 25° Celsius and/or charged at 4.2V may reach 80% of its initial capacity and increase in thickness by 8% after 1050 charge-discharge cycles. However, use of the same battery at 45° Celsius and/or a charge voltage of 4.3V may decrease the capacity to 70% of its initial capacity and increase the swelling to 10% after 1050 charge-discharge cycles.

Second, swelling and/or degradation in battery 110 may be affected by periods during which battery 110 rests at certain states-of-charge. For example, extended resting of battery 110 at a very high (e.g., 100%) state-of-charge may accelerate cathode oxidation and/or swelling in battery 110. As a result, continued charging of battery 110 to maintain a fully charged state may prematurely age battery 110, even if battery 110 is not being used to supply power to portable electronic device 102.

In one or more embodiments, portable electronic device 102 includes functionality to dynamically manage battery 110 runtime, cycle life, and/or swelling in response to user behavior with respect to charging and discharging of battery 110 in portable electronic device 102. During use of battery 110 with portable electronic device 102, a monitoring apparatus such as charger 104, a gas-gauge circuit 108, or a battery management unit (BMU) and/or one or more sensors may monitor one or more battery-usage parameters of battery 110.

For example, the monitoring apparatus may monitor charging and discharging of battery 110 over time by detecting the presence or absence of power source 112 and/or obtaining the state-of-charge, impedance, capacity, charging voltage, and/or remaining charge of battery 110 from gas-gauge circuit 108. The monitoring apparatus may also measure the voltage, current, temperature, swell rate, cycle number, battery age, and/or a cell balance of battery 110. The monitoring apparatus may further include processor 106, which may obtain data related to usage patterns of portable electronic device 102, such as the applications used on portable electronic device 102, the time periods during which the applications are used, user settings on portable electronic device 102, events and/or alarms scheduled on portable electronic device 102, the use of power-saving modes on portable electronic device 102, and/or the location of portable electronic device 102.

Next, a management apparatus on portable electronic device 102 may modify the charging technique for battery 110 based on the monitored user behavior, which in turn may help to manage the cycle life, swelling, and/or runtime of battery 110. Like the monitoring apparatus, the management apparatus may be provided by a number of components in portable electronic device 102, including processor 106, charger 104, and/or a system microcontroller (SMC) (not shown).

For example, processor 106 may be a central-processing unit (CPU), application processor, and/or microprocessor that communicate directly with gas-gauge circuit 108 and/or through charger 104. To manage the charging technique for battery 110, processor 106 may set a flag for a state-of-charge of battery 110. Once battery 110 reaches the state-of-charge, gas-gauge circuit 108 may raise the flag, and processor 106 may perform an action related to charging or discharging of the battery in response to the flag. Processor 106 may alternatively poll the state-of-charge of battery 110 from gas-gauge circuit 108 at regular intervals (e.g., every few minutes) and manage charging and/or discharging of battery 110 based on the polled state-of-charge.

In another example, the management apparatus may include charger 104, which is configured by processor 106 and/or another mechanism to modify charging of battery 110 based on states-of-charge from gas-gauge circuit 108. The use of charger 104 to manage the charging technique for battery 110 may allow user-behavior-driven battery charging to be performed even when battery 110 is fully discharged, processor 106 is disabled, and/or portable electronic device 102 is switched off.

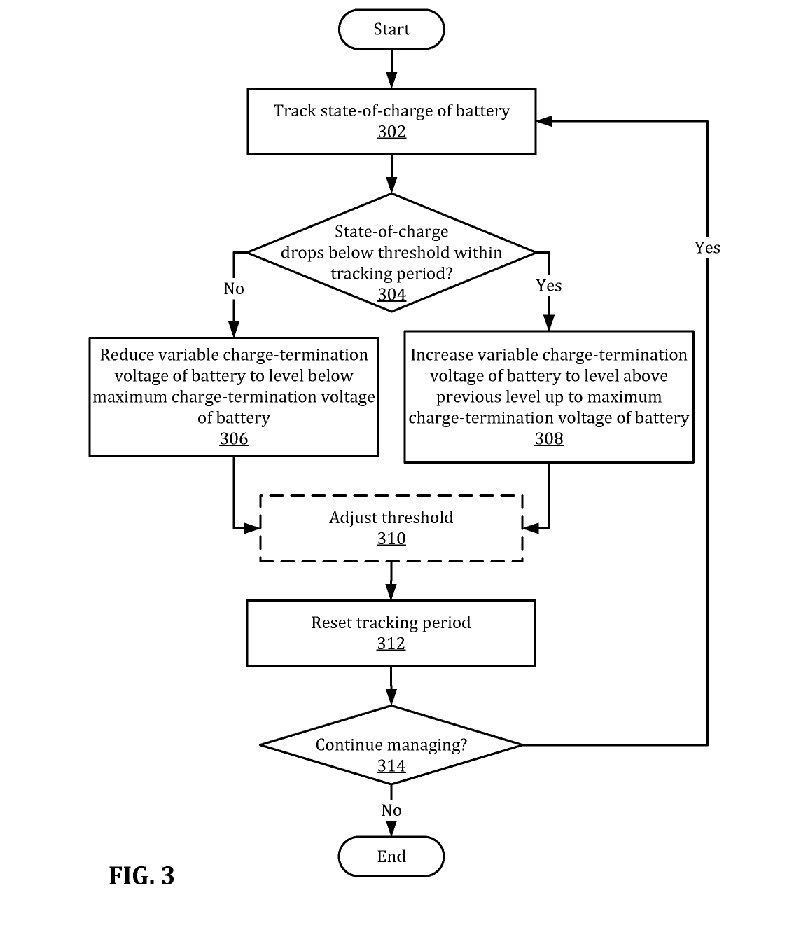

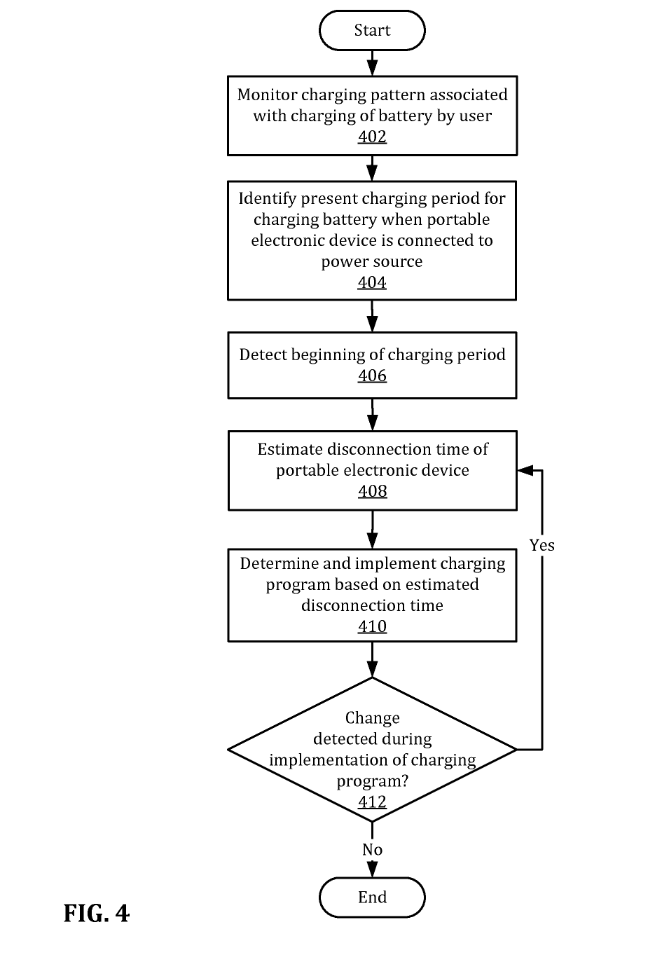

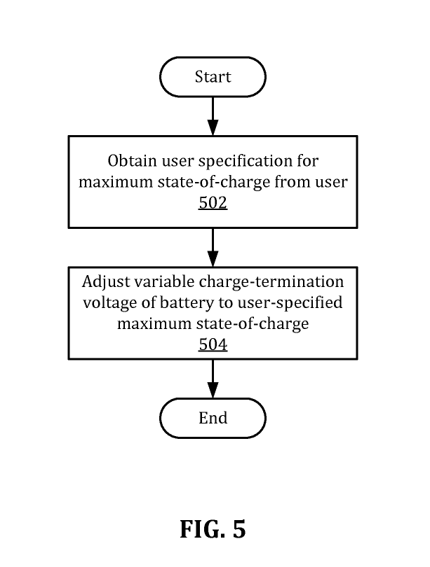

In one or more embodiments, the monitoring apparatus, management apparatus, and/or other components of portable electronic device 102 manage charging and/or discharging of battery 110 based on a number of user behaviors and/or related parameters. In some embodiments, a variable charge-termination voltage of battery 110 may be adjusted to one or more levels based on a state-of-charge reached by battery 110 within a tracking period, as described in further detail below with respect to FIG. 3. Additionally or alternatively, charging of battery 110 may be modified based on user charging patterns and/or disconnection time from a power source associated with charging of battery 110 by the user, as described in further detail below with respect to FIG. 4. Additionally or alternatively, a maximum charge-termination voltage of battery 110 may be adjusted according to a user preference, which may or may not limit variation of a variable charge-termination from the maximum charge-termination voltage, as described in further detail below with respect to FIG. 5.

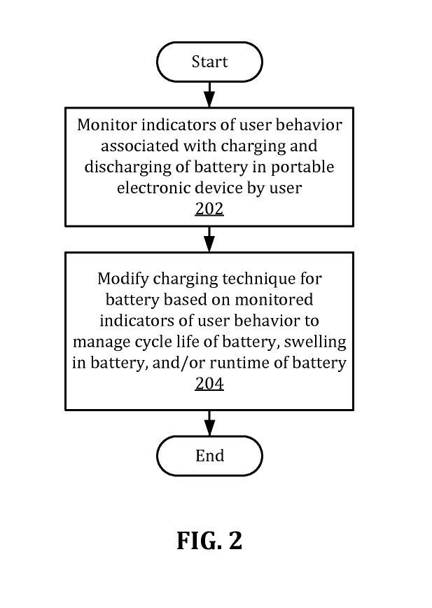

FIG. 2 shows a flowchart illustrating the process of managing use of a battery in a portable electronic device in accordance with the disclosed embodiments. In one or more embodiments, one or more of the steps may be omitted, repeated, and/or performed in a different order. Accordingly, the specific arrangement of steps shown in FIG. 2 should not be construed as limiting the scope of the embodiments.

Initially, the system monitors indicators of user behavior associated with charging and discharging of the battery in the portable electronic device by the user (operation 202). For example, the indicators of user behavior may be monitored by a monitoring apparatus such as a gas-gauge circuit, charger, sensor, processor, BMU and/or other monitoring mechanism in the portable electronic device. The indicators of user behavior can include: a state-of-charge of the battery, a charging pattern associated with charging of the battery, and/or a user preference for charging and/or discharging of the battery. The indicators of user behavior may also include usage of applications on the portable electronic device, user settings with the portable electronic device, scheduled events or alarms on the portable electronic device, power consumption patterns or modes of operation on the portable electronic device, the time of day, and/or the location of the portable electronic device.

Next, a charging technique for the battery is modified based on the monitored indicators of user behavior to manage at least one of a cycle life of the battery, swelling in the battery, and a runtime of the battery (operation 204). For example, the charging technique may be modified by a management apparatus such as a processor, SMC, charger, BMU and/or other processor or circuit in the portable electronic device. In addition, the charging technique may be modified to extend the cycle life of the battery and/or reduce swelling in the battery while providing a battery runtime that accommodates the user behavior of the user. For example, degradation and/or swelling associated with high states-of-charge in the battery may be mitigated by adjusting the charging technique so that the battery spends less time at high voltages. Moreover, the charging technique may be modified in a way that is not noticeable by the user and/or does not interfere with the user's regular use of the portable electronic device, as discussed below.

FIG. 3 shows a flowchart illustrating the process of managing use of a battery in a portable electronic device in accordance with some of the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, the state-of-charge of the battery is tracked (operation 302). For example, the state-of-charge may be provided by a gas-gauge circuit in the portable electronic device and tracked over time by a processor, charger, BMU and/or SMC in the portable electronic device. In other words, tracking of the state-of-charge may indirectly comprise monitoring of a user behavior associated with charging and discharging of the battery by a user. In some instances, the state-of-charge may be tracked as a default state-of-charge, a variable state-of-charge, or a state-of-charge calculated by another metric.

Next, the variable charge-termination voltage of the battery can be adjusted based on the tracked state-of-charge of the battery. In particular, the state-of-charge may be compared to a state-of-charge threshold during a tracking period to determine if the state-of-charge drops below the state-of-charge threshold (operation 304).

The tracking period may be based on one or more periods of time and/or types of events. For example, the tracking period may be a time period (e.g., one day, two days or the like), a length of on-time of the portable electronic device (e.g., one day of device on-time), or a length of time until a cumulative length of charging time during which the portable electronic device is charged reaches a threshold (e.g., the tracking period may be the length of time that passes until the portable electronic device has been charged for three hours).

In other instances, the tracking period may be a number of events, such as a number of charge-discharge events, in which the user discharges the battery and subsequently charges the battery. Different criteria may be used to determine what constitutes a charge-discharge event. In some instances, a charge-discharge event may be defined as charging the battery to provide a threshold amount of state-of-charge increase. For example, in some of these instances a charge-discharge event may be defined as a 30% increase in state-of-charge. The 30% increase may occur during a single charging event (e.g., an increase in the state-of-charge from 40% to 70%, or 70% to 100% in a single charging session) or over cumulatively over multiple charging events (e.g., charging the battery from 10% to 25% state-of-charge in a first charging session, and charging the battery from 20% to 35% state-of-charge in a second charging session). In other instances, a charge-discharge event may be defined as charging from and/or to a particular state-of-charge. In some variations, a charge-discharge event may be registered each time the battery is charged from a state-of-charge below a first threshold to a state-of-charge at or above the first threshold (e.g., a charge-discharge event may be registered when a battery is charged from below 90% state-of-charge to 90% state-of-charge the charge-discharge period). In some of these variations, a charge-discharge event is registered when the battery is charged from a state-of-charge below a first threshold to a state-of-charge at or above a second threshold (e.g., a charge-discharge may be registered when the battery is charged from a state-of-charge below 50% to a state-of-charge at or above 90%). By requiring charging between two threshold states of charges, the system may be able to avoid frequent connections and disconnections from a power source with minimal charging from being counted as charge-discharge events.

In some instances, a tracking period may be based on two or more time periods and/or types of events. In some instances, multiple periods of times and/or types of events may be tracked simultaneously (each having a threshold value), and the tracking period may end when the first threshold (or a first group of thresholds) is met. For example, the tracking period may be whichever of a time period of 2 days or 10 charge-discharge events occurs first. In other instances, multiple periods of times and/or types of events may be tracked simultaneously (each having a threshold value), and the tracking period may be end when all thresholds are met. For example, the tracking period may end when both a time period of 1 day and 3 charge-discharge events have occurred.

As mentioned above, the variable charge-termination voltage may be adjusted depending on whether the state-of-charge of the battery falls below a state-of-charge threshold during a tracking period. The state-of-charge threshold may be set with reference to a default or variable state-of-charge of the battery, such as 50% of the default maximum state-of-charge. As a result, the battery's state-of-charge may not fall below the state-of-charge threshold if the battery stays above 50% of the default maximum state-of-charge throughout the entire tracking period. Conversely, the battery's state-of-charge may fall below the state-of-charge threshold if the battery discharges to less than 50% of the default state-of-charge at any point within the tracking period. In some instances, the tracking period may be reset when the battery is charged such that the state-of-charge is again above the state-of-charge threshold.

If the battery's state-of-charge does not drop below the state-of-charge threshold within the tracking period, the variable charge-termination voltage of the battery is reduced to a level below the previous variable charge-termination voltage and the maximum charge-termination voltage of the battery (operation 306). For example, the battery's variable charge-termination voltage may be reduced by a pre-specified voltage (e.g., 50 mV) or as a percentage (e.g., 5% or 1%) of the maximum and/or previous variable charge-termination voltage after each tracking period in which the battery's state-of-charge does not drop below the state-of-charge threshold. In one embodiment, the variable charge termination voltage may be set based on the state of charge threshold being about 80% of the designed Full Charge Capacity (FCC) in mAh of the battery's state of charge. In another embodiment, the variable charge-termination voltage may be lowered until the variable charge-termination voltage is not below a lower-limit variable charge-termination voltage, after which the lower-limit variable charge-termination voltage is maintained at the lower-limit for subsequent tracking periods.

On the other hand, if the battery's state-of-charge drops below the state-of-charge threshold within the tracking period, the variable charge-termination voltage of the battery is increased to a level above the previous variable charge-termination voltage, up to the maximum charge-termination voltage of the battery (operation 308). Continuing with the above example, the battery's variable charge-termination voltage may be increased by a pre-specified percentage (e.g. 5% or 1%) of the maximum or previous variable charge-termination voltage or by a pre-specified amount (e.g., 50 mV). The variable charge-termination voltage may increase with successive tracking periods in which the state-of-charge drops below the state-of-charge threshold until the maximum charge-termination voltage is reached and/or the battery's state-of-charge no longer drops below the state-of-charge threshold within a given tracking period. When the variable charge-termination voltage is equal to the maximum charge-termination voltage, the variable charge-termination voltage may be maintained at the maximum charge-termination voltage if the state-of-charge continues to fall below the state-of-charge threshold.

Those skilled in the art will appreciate that the variable charge-termination voltage may be adjusted a number of ways. In some instances, the magnitude of an increase or decrease in the variable charge-termination voltage may be based on the number of consecutive tracking periods resulting in previous increases or decreases in the variable charge-termination voltage. For example, a reduction in variable charge-termination voltage may be increased by a pre-specified amount (e.g., 10 mV) after each tracking period in which the state-of-charge does not fall below the state-of-charge threshold. If the variable charge-termination voltage is reduced by 50 mV reduction after the first tracking period in which the state-of-charge stays above the state-of-charge threshold, it may be reduced by 60 mV after the second consecutive tracking period in which the state-of-charge stays above the state-of-charge threshold, and 70 mV after the third consecutive tracking period in which the state-of-charge stays above the state-of-charge threshold. Similarly, the magnitude of the increase in the variable charge-termination voltage by be increased by a pre-specified amount after each consecutive tracking period in which the state-of-charge falls below the state-of-charge threshold). Once a consecutive string of variable charge-termination voltage increases or decrease has been broken, the magnitude of the reduction or increase in the variable charge-termination voltage may be reset to its original value. Such scaling of adjustments to the variable charge-termination voltage may allow the charging technique to reach equilibrium more quickly.

In other instances, the variable charge-termination voltage may be increased and/or decreased to the nearest of a discrete set of values. For example, a set of values may include the maximum charge-termination voltage, 80% of the maximum charge-termination voltage, and 60% of the maximum charge-termination voltage. If the variable charge-termination voltage is currently between 60% and 80% of the maximum charge-termination voltage and the state-of-charge falls below the state-of-charge threshold during a tracking period, the variable charge-termination voltage may be set to 80% of the maximum charge-termination voltage at the end of the tracking period.

In still other instances, the amount the variable charge-termination voltage may be increased and/or decreased may be calculated using the lowest state-of-charge the battery achieves during the tracking period. For example, if the state-of-charge does not fall below the state-of-charge threshold during the tracking period, the lowest state-of-charge represents how close the user came to reaching the state-of-charge threshold. Accordingly, in some embodiments, the magnitude of decrease of the variable charge-termination voltage may be proportional to the lowest state-of-charge value (i.e., the larger the lowest state-of-charge, the larger the decrease in variable charge-termination voltage). Conversely, if the state-of-charge does fall below the state-of-charge threshold during the tracking period, the lowest state-of-charge may represents how much additional runtime the user used beyond that anticipated by the threshold. In some embodiments, the magnitude of the increase of the variable charge-termination voltage may be inversely proportional to the lowest state-of-charge value (i.e., the smaller the lowest state-of-charge value, the larger the increase in variable charge-termination voltage). For example, the battery's variable charge-termination voltage may be increased from 80% of the default maximum charge-termination voltage, to 85% of the default maximum charge-termination voltage if the battery's state-of-charge falls to between 30% and 50% within a tracking period. If the battery's state-of-charge falls to below 30% within the tracking period, the battery's variable charge-termination voltage may instead be increased more aggressively to 95% of the default maximum charge-termination voltage (which may reduce the likelihood that the battery is fully depleted during subsequent use of the portable electronic device).

It should also be appreciated that the variable charge-termination voltage may be increased according to one set of criteria while decreased according to another set of criteria, each of which may be selected from any framework described above or the like (e.g., the charge-termination voltage may be reduced by a predetermined amount of voltage, while the charge-termination voltage may be increased to the nearest of a discrete set of values).

The state-of-charge threshold may optionally be adjusted (operation 310) after each tracking period and/or change to the battery's charge-termination voltage. The state-of-charge threshold may be based on the maximum charge-termination voltage, the variable charge-termination voltage, and/or a voltage value. For example, a 50% threshold for the battery's state-of-charge may be set relative to the maximum or variable charge-termination voltage. As a result, a 50% threshold for a variable state-of-charge may be adjusted whenever the variable charge-termination voltage is adjusted after a tracking period, while a 50% threshold for default state-of-charge may be adjusted whenever the default maximum charge-termination voltage is adjusted (e.g., after a number of charge-discharge cycles). Alternatively, the state-of-charge threshold may set to a pre-specified voltage value (e.g., 3.3V) and optionally adjusted by another pre-specified voltage value (e.g., 50 mV) in response to increases or decreases in the variable charge-termination voltage.

After the variable charge-termination voltage and/or threshold are adjusted, the tracking period is reset (operation 312). For example, a counter representing the tracking of time and/or charging or discharging of the battery during the tracking period may be reset. As with the variable charge-termination voltage and the state-of-charge threshold, the tracking period may also be adjusted after the previous tracking period has ended. For example, the tracking period may be decreased with each successive tracking period in which the state-of-charge continues a pattern of falling below or staying above the state-of-charge threshold to allow the variable charge-termination voltage to reach a stable value at a faster rate. The tracking period may then be reset to the original value after the state-of-charge breaks the pattern. Conversely, the tracking period may be kept the same between consecutive tracking periods.

Management of the battery may continue (operation 314). For example, the battery may be managed during use of the battery to power components in the portable electronic device. If management of the battery is to continue, the battery's state-of-charge may again be tracked (operation 302) and compared with the state-of-charge threshold to determine if the state-of-charge drops below the state-of-charge threshold in another tracking period (operation 304). Monitoring and management of the battery may thus continue until the battery is replaced and/or the battery is no longer used to power the portable electronic device. Accordingly, the battery management described above may be used to set a variable charge-termination voltage to a level that should satisfy user needs (based on the user's recent history of discharging and charging the battery) while also helping maximize the useful life of the battery.

If the state-of-charge does not drop below the state-of-charge threshold within each tracking period, the battery's variable charge-termination voltage may be reduced to a level below the maximum charge-termination voltage of the battery (operation 306). For example, the battery's variable charge-termination voltage may be reduced from 100% of the default maximum charge-termination voltage, to 90% of the default maximum charge-termination voltage, to 85% of the default maximum charge-termination voltage, and to an 80% of the default maximum charge-termination voltage after three respective tracking periods in which the battery's state-of-charge does not drop below the state-of-charge threshold.

If the state-of-charge drops below the state-of-charge threshold within the tracking period, the battery's variable charge-termination voltage may be increased to a level above the previous level up to the default maximum charge-termination voltage of the battery (operation 308). The variable charge-termination voltage may further be increased according to the amount by which the battery's state-of-charge drops below the state-of-charge threshold.

The state-of-charge threshold may optionally be adjusted (operation 310) after each tracking period based on the variable charge-termination voltage of the battery and/or the lowest state-of-charge reached by the battery. For example, the state-of-charge threshold may be set to be consistent with a percentage of the battery's maximum or variable charge-termination voltage and/or to be within a certain percentage of the lowest state-of-charge reached by the battery in the previous tracking period. The tracking period may also be reset (operation 312) to start a new tracking period in which the state-of-charge of the battery is tracked and used to manage charging of the battery (operations 302-310).

FIG. 4 shows a flowchart illustrating the process of managing use of a battery in a portable electronic device in accordance with another of the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

In some variations, a charging pattern associated with charging of the battery by a user is monitored (operation 402). Note that monitoring the charging pattern may be an indirect technique for monitoring user behavior associated with charging and discharging of the battery by the user.

For example, the charging pattern may be monitored by tracking time periods in which the battery is charged and/or discharged. In some instances, the portable electronic device may track the times at which the portable electronic device is connected to a power source, as well as the times at which the portable electronic device is subsequently disconnected from the power source. When the portable electronic device is again connected to a power source, this information may aid the portable electronic device in estimating a disconnection time at which the portable electronic device will be disconnected from the power source.

In some instances, the charging patterns of the user monitored by the portable electronic device may be categorized into one or more charging periods. Each charging period may relate to one or more times, locations, and/or device settings. In some examples, the monitored charging patterns may be categorized according to different times of day. For example, a first charging period may correspond to a user connecting the portable electronic device at a specific time of day (e.g., between 10 PM and 12 AM). Accordingly, the portable electronic device may collect information about user charging habits during the first charging period. For example, the portable electronic device may calculate an average time between connection to a power source in the first charging period and a subsequent disconnection from the power source (e.g., when a user connects the portable electronic device to a power source between 10 PM and 12 AM, the user may leave the device connected to the power source for an average of eight hours). Additionally or alternatively, the portable electronic device may track the maximum and/or minimum times between connection to a power source in the first charging period and a subsequent disconnection from the power source.

In some instances, charging periods may be specific to one or more days of the weeks. For example, there may be one or more charging periods specific to each day of the week (which may allow the device to identify user trends for each day). In other instances, there may be one or more charging periods specific to weekdays and one or more charging periods specific to weekends (which may allow the portable electronic device to identify user trends specific to the weekend and user trends specific to the workweek). Additionally or alternatively, charging periods may be location-specific, which may allow the portable electronic device to detect user trends when charging at a specific location. For example, a user may typically charge a device for only a brief length of time while at work, but may charge the device for a longer amount of time when at home. Additionally or alternatively, charging periods may be specific to one or more device settings or metrics. For example, there may be one or more charging periods for when a user has an alarm activated and may be one or more charging periods for when a user does not have an alarm activated. This may allow the portable electronic device to track user trends when an alarm is set. For example, a user may consistently disconnect the device from a power source at the time set by the alarm, or may consistently disconnect the device at least 30 minutes following the time set by the alarm. Other examples of device settings and metrics include, but are not limited to, a scheduled event on the portable electronic device, whether a battery saving mode is activated by the user, a battery state-of-charge when the device is connected to the power source, or the like. It should be appreciated that a charging period may be based on any combination of the foregoing (e.g., a charging period may track user charging patterns for a given time of day on a weekend day when a user is at home and does not have an alarm set).

In variations where user charging patterns are tracked using one or more charging periods, the portable electronic device may identify a present charging period when the portable electronic device is connected to a power source (operation 404). Charging patterns associated with the present charging period may be used to help calculate an estimated disconnection time at which the portable electronic device may be disconnected from the power source. Additionally or alternatively, the actual time at which the portable electronic device is disconnected from the power source may be used to update the charging patterns associated with the present charging period.

After connection of the portable electronic device to a power source has been detected (operation 406), a disconnection time of the portable electronic device is estimated (operation 408). The disconnection time may be estimated based on one or more parameters. For example, in some variations the disconnection time may be estimated using a monitored charging pattern of the user. In variations where a present charging period is identified (e.g., from operation 406), the disconnection time may be estimated using the monitored charging patterns specific to the present charging period. Additionally or alternatively, the disconnection time may be estimated using one or more of the following: the current time of day or day of week, the current location of the portable electronic device, one or more user setting or metrics (e.g., an alarm set on the portable electronic device, a scheduled event on the electronic device, or the like).

A charging program is then determined and implemented (operation 410) during charging of the battery based on the estimated disconnection time. The charging program may be set to allow the battery to charge fully before the estimated disconnection time is reached while reducing the amount of time that the battery spends at high states-of-charge and/or voltages. In some instances, implementing the charging program may include selecting or otherwise adjusting a charging rate of the battery based on the estimated disconnection time. For example, the C-rate for charging the battery may be reduced whenever the battery enters a prolonged charging period to reduce degradation associated with fast charging of the battery and/or keeping the battery at a fully charged state. Conversely, the C-rate may be increased if the charging pattern indicates a relatively short charging period to allow the battery to charge faster during the short charging period.

Additionally or alternatively, the charging program may be set such that charging of the battery may be paused at one or more points before the estimated disconnection time. To pause charging of the battery, the charging profile may include one or more pause thresholds for the battery's state-of-charge. When the battery's state-of-charge reaches a pause threshold during the charging period, the charging of the battery may be paused and resumed a pre-specified time prior to the estimated disconnection time to complete charging of the battery before the end of the charging period. For example, charging of the battery may be paused when the state-of-charge of the battery reaches an 80% pause threshold. Charging may then be resumed an hour before the estimated disconnection time to allow the battery to reach a fully charged state before the battery is estimated to be disconnected from the power adapter. In these instances, even if the portable electronic device is disconnected before the charging resumes, the user will still have 80% battery life for use. Additionally, the battery may remain at the fully charged state for less time than if the battery were continuously charged to a fully charged state, and kept at the fully charged state for the remainder of the charging period. In another example, the battery charging may be paused at multiple pause thresholds, and resume charging after each threshold based on a respective pre-specified time prior to the estimated disconnection time. For example, charging of the battery may be paused at a first 60% pause threshold, resumed two hours prior to the estimated disconnection time, paused again when the state-of-charge reaches a second 80% pause threshold, and then resumed again an hour prior to the estimated disconnection time to enable full charging of the battery before the estimated disconnection time. The pause threshold may further be set to a value (e.g., 80-90%) that allows the battery to be used for an extended period in case the charging is interrupted (e.g., in the case of an emergency or power outage) and/or the charging ends early (e.g., if the user disconnects the portable electronic device from the power supply prior to the estimated disconnection time).

Adjustments of the charging rate of the battery may additionally be combined with pausing of charging of the battery. For example, the rate at which the battery may be charged prior to reaching a particular pause threshold may be slower than the rate at which the battery is charged when charging resumes.

In some variations, an event or change in the portable electronic device may be detected during implementation of the charging program (operation 412). For example, an event or change may include the addition or changing of an alarm, the addition of a scheduled event, and/or use of the portable electronic device during a period in which no use is anticipated (e.g., in the early morning when a user is typically sleeping). If such an event or change is identified during the charging program, the disconnection time may be re-estimated (operation 408), and the charging program may be updated based on the new estimate (operation 410). For example, an earlier disconnection time may be estimated if a new alarm is scheduled for a time prior to the estimated disconnection time and/or use of the portable electronic device occurs earlier than the estimated disconnection time. In turn, the earlier estimated disconnection time may result in the omission of one or more charging pauses from the charging profile, a reduction in the duration of a charging pause, and/or an increase in the charging rate of the battery. Conversely, a later disconnection time may be estimated if an alarm is rescheduled to be later, an event is moved to a later time, and/or use of the portable electronic device does not occur when expected. The later disconnection time may result in the addition of one or more charging pauses to the charging profile, an increase in the duration of a charging pause, and/or a reduction in the charging rate of the battery. Charging of the battery based on the charging pattern, charging profile, and/or estimated disconnection time may continue until the portable electronic device is fully charged and/or disconnected from the power source.

FIG. 5 shows a flowchart illustrating the process of managing use of a battery in a portable electronic device in accordance with another of the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

As mentioned above, in some instances the maximum charge-termination voltage may be based on user input. Initially, a user preference for a battery capacity is obtained from a user (operation 502). The user preference may be obtained from a user interface of the portable electronic device. For example, the user interface may display a slider that allows the user to specify a setting for the battery's capacity between a minimum value and maximum value as set by the system. The user interface may also inform the user that a lower maximum state-of-charge may increase the cycle life of the battery and/or slow degradation or swelling in the battery.

Next, the maximum charge-termination voltage of the battery is adjusted to be consistent with the user-specified battery capacity (operation 504). For example, the maximum charge-termination voltage may be lowered to help increase cycle life of the battery.

Conversely, the maximum charge-termination voltage may be increased to improve the battery's runtime in response to the user preference. In some instances, the battery's variable charge-termination voltage may be increased only a limited number of times in response to user requests for extended runtime of the battery. For example, the user may request an “overcharge” of the battery if the user anticipates extended use of the portable electronic device without access to an external power source. Consequently, adjustment of the battery's variable charge-termination voltage based on the user preference may allow the user to take part in managing the tradeoff between battery runtime, cycle life, and swelling.

It should be appreciated that when the maximum charge-termination voltage is set based on user input, the variable charge-termination voltage may or may not be set to the maximum charge-termination voltage. For example, in instances where the maximum charge-termination voltage is lowered based on user input, the variable charge-termination voltage may still be lowered below the maximum charge-termination voltage (e.g., utilizing the methods described with respect to FIG. 3 above). Conversely, in instances where the maximum charge-termination voltage is increased in response to a user request for an “overcharge”, the variable charge-termination may be set to the maximum charge-termination voltage (since the user is presumably requesting additional runtime based on expected device usage).

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for managing use of a battery in a portable electronic device, comprising:
tracking a state-of-charge of the battery;
adjusting a variable charge-termination voltage of the battery based on whether the tracked state-of-charge of the battery falls below a state-of-charge during a first tracking period; and
using the variable charge-termination voltage as a target voltage while charging the battery during a subsequent charging operation.

2. The computer-implemented method of claim 1, wherein adjusting the variable charge-termination voltage of the battery comprises:
upon determining that the state-of-charge of the battery does not drop below a state-of-charge threshold within the first tracking period, reducing the variable charge-termination voltage to a first level below a maximum charge-termination voltage of the battery.

3. The computer-implemented method of claim 2, wherein adjusting the variable charge-termination voltage of the battery further comprises:
upon determining that the state-of-charge of the battery does not drop below the state-of-charge threshold within a second tracking period after the variable charge-termination voltage is reduced to the first level, reducing the variable charge-termination voltage to a second level below the first level.

4. The computer-implemented method of claim 2, wherein adjusting the variable charge-termination voltage of the battery based on the monitored state-of-charge of the battery further comprises:
upon determining that the state-of-charge of the battery drops below the state-of-charge threshold within a second tracking period after the charge-termination voltage is reduced to the first level, increasing the variable charge-termination level to a third level above the first level.

5. The computer-implemented method of claim 4, wherein the third level is less than the maximum charge-termination voltage.

6. The computer-implemented method of claim 1, wherein the method further comprises:
obtaining a specification for a desired maximum state-of-charge of the battery from the user, and
adjusting the variable charge-termination voltage of the battery to be consistent with the user-specified maximum state-of-charge.

7. The computer-implemented method of claim 2, wherein the method further comprises adjusting the maximum charge-termination voltage for the battery based on one or more factors including a cycle count that specifies how many charging cycles the battery has gone through.

8. The computer-implemented method of claim 1, wherein the method further comprises adjusting a charging rate for the battery during the subsequent charging operation based on one or more factors including the tracked state-of-charge of the battery.

9. A non-transitory computer-readable storage medium storing instructions that when executed by a computer cause the computer to perform a method for managing use of a battery in a portable electronic device, the method comprising:
tracking a state-of-charge of the battery;
adjusting a variable charge-termination voltage of the battery based on whether the tracked state-of-charge of the battery falls below a state-of-charge during a first tracking period; and
using the variable charge-termination voltage as a target voltage while charging the battery during a subsequent charging operation.

10. The non-transitory computer-readable storage medium of claim 9, wherein adjusting the variable charge-termination voltage of the battery comprises:
upon determining that the state-of-charge of the battery does not drop below a state-of-charge threshold within the first tracking period, reducing the variable charge-termination voltage to a first level below a maximum charge-termination voltage of the battery.

11. The non-transitory computer-readable storage medium of claim 10, wherein adjusting the variable charge-termination voltage of the battery further comprises:
upon determining that the state-of-charge of the battery does not drop below the state-of-charge threshold within a second tracking period after the variable charge-termination voltage is reduced to the first level, reducing the variable charge-termination voltage to a second level below the first level.

12. The non-transitory computer-readable storage medium of claim 10, wherein adjusting the variable charge-termination voltage of the battery based on the monitored state-of-charge of the battery further comprises:
upon determining that the state-of-charge of the battery drops below the state-of-charge threshold within a second tracking period after the charge-termination voltage is reduced to the first level, increasing the variable charge-termination level to a third level above the first level.

13. The non-transitory computer-readable storage medium of claim 12, wherein the third level is less than the maximum charge-termination voltage.

14. The non-transitory computer-readable storage medium of claim 12, wherein the third level is equal to the maximum charge-termination voltage.

15. The non-transitory computer-readable storage medium of claim 9, wherein the method further comprises:
obtaining a specification for a desired maximum state-of-charge of the battery from the user, and
adjusting the variable charge-termination voltage of the battery to be consistent with the user-specified maximum state-of-charge.

16. The non-transitory computer-readable storage medium of claim 9, wherein the method further comprises adjusting the maximum charge-termination voltage for the battery based on one or more factors including a cycle count that specifies how many charging cycles the battery has gone through.

17. The non-transitory computer-readable storage medium of claim 9, wherein the method further comprises adjusting a charging rate for the battery during the subsequent charging operation based on one or more factors including the tracked state-of-charge of the battery.

18. A system that manages use of a battery in a portable electronic device, comprising:
a charging system for the battery, wherein the charging system is configured to:
track a state-of-charge of the battery;
adjust a variable charge-termination voltage of the battery based on whether the tracked state-of-charge of the battery falls below a state-of-charge during a first tracking period; and
use the variable charge-termination voltage as a target voltage while charging the battery during a subsequent charging operation.

19. The system of claim 18, wherein while adjusting the variable charge-termination voltage of the battery, the charging system is configured to:
upon determining that the state-of-charge of the battery does not drop below a state-of-charge threshold within the first tracking period, reduce the variable charge-termination voltage to a first level below a maximum charge-termination voltage of the battery.

20. The system of claim 19, wherein while adjusting the variable charge-termination voltage of the battery, the charging system is further configured to:
upon determining that the state-of-charge of the battery does not drop below the state-of-charge threshold within a second tracking period after the variable charge-termination voltage is reduced to the first level, reduce the variable charge-termination voltage to a second level below the first level.

21. The system of claim 19, wherein while adjusting the variable charge-termination voltage of the battery based on the monitored state-of-charge of the battery, the charging system is further configured to
upon determining that the state-of-charge of the battery drops below the state-of-charge threshold within a second tracking period after the charge-termination voltage is reduced to the first level, increase the variable charge-termination level to a third level above the first level.

22. The system of claim 21, wherein the third level is less than the maximum charge-termination voltage.

23. The system of claim 21, wherein the third level is equal to the maximum charge-termination voltage.

24. A system that manages use of a battery in a portable electronic device, comprising:
a charging system for the battery, wherein the charging system is configured to:
determine that the portable electronic device is connected to a power source;
estimate a disconnection time at which the portable electronic device will be disconnected from the power source;
select a charging program based on the disconnection time; and
charge the battery according to the selected charging program.

25. The system of claim 24, wherein while charging the battery according to the selected charging program, the charging system is configured to:
initially charge the battery;
pause charging of the battery after a state-of-charge of the battery reaches a first threshold that is lower than a full state-of-charge of the battery; and
resume charging of the battery a pre-specified amount of time prior to the estimated disconnection time.

26. The system of claim 24, wherein while estimating the disconnection time, the charging system is configured to estimate the disconnection time using one or more of the following:
a day of the week during which the portable electronic device is connected to the power source;
a time of day during which the portable electronic device is connected to the power source;
a scheduled event on the portable electronic device;
an alarm that is set on the portable electronic device; and
a location of the portable electronic device where portable electronic device is connected to the power source.

27. The system of claim 24, wherein the charging system is further configured to re-estimate the disconnection time, and select a new charging program if the re-estimated disconnection time is different than the estimated disconnection time.
